(19) United States
(12) Patent Application Publication
(10) Pub. No.: US 2018/0370059 A1
(43) Pub. Date: Dec. 27, 2018

(54) SLITTER

(71) Applicant: MOTO INDUSTRIES CO., LTD., Taoyuan (TW)

(72) Inventor: Yu-Chang HSU, Taoyuan (TW)

(21) Appl. No.: 15/634,943

(22) Filed: Jun. 27, 2017

(51) Int. Cl. B26D 7/26; B26D 5/02

(52) U.S. Cl. CPC B26D 7/2635; B26D 2007/2657; B26D 5/02

(57) ABSTRACT

A slitter having a first slide, a first driving rail, multiple round knife modules, a second slide, a second driving rail, multiple bottom cutter modules and at least a controller is provided. The round knife module is arranged on the first slide, each round knife module is provided with a first actuator geared with the first driving rail. Each bottom cutter module is arranged on the second slide corresponding to a position of one of the round knife modules, each bottom cutter module is provided with a second actuator geared with the second driving rail. Each first actuator and the corresponding second actuator are electrically connected with the corresponding controller. The round knife module and the bottom cutter module are respectively moved by individual first actuator and second actuator. While the round knife module and the bottom cutter module are moving, material could be fed between them.

### BACKGROUND OF THE INVENTION

### Technical Field

The present disclosure relates to a slitter, in particular to a slitter which is able to feeding material while moving knives.

### Description of Related Art

A slitter is a machine used for cutting a sheet material; the slitter includes a rotatable round knife and a bottom cutter. The round knife pressed on the bottom cutter while cutting, the sheet material is continually fed to pass between the round knife and the bottom cutter bottom cutter and is thereby cut into multiple strips of equal width. A conventional slitter includes multiple round knives and corresponding bottom cutters for cutting material into multiple strips, the round knives and the bottom cutters could be moved to adjust intervals therebetween, and the slitter could thereby cut the material into strips of various widths.

An original slitter has to be shut down while adjusting widths of the strips, the round knives and the bottom cutters have to be calibrated after an adjustment in order to align the respective round knives to the corresponding bottom cutters, and it is therefore inconvenient. A conventional slitter could move round knives by automatic control, each round knife extends a pushing rod to connect with the corresponding bottom cutter and thereby moves along with the bottom cutter, and an alignment process is therefore not required. However, a feeding path is blocked by the pushing rod, so a feeding process is interrupted by the adjustment process. Further time is wasted for the alignment process of a wide material before the feeding process.

A slitter is usually arranged at an end of a production line. A production line cannot be paused arbitrarily, and products manufactured during the adjustment process therefore should be abandoned if the feeding process and the adjustment process cannot be run at the same time. For example, a paper machine output 1000 meters of products per minute, so a large amount of product is abandoned during pause conditions for the adjustment process.

In views of this, in order to solve the above disadvantage, the present inventor studied related technology and provided a reasonable and effective solution in the present disclosure.

### SUMMARY

A slitter which is able to adjust knives and feed material at the same time is provided in the present disclosure.

A slitter including a first slide, a first driving rail, multiple round knife modules, a second slide, a second driving rail, multiple bottom cutter modules and at least a controller is provided in the present disclosure. The round knife modules are arranged on the first slide, each round knife module is provided with a first actuator geared with the first driving rail. Each bottom cutter module is arranged on the second slide corresponding to a position of one of the round knife modules, and each bottom cutter module is provided with a second actuator geared with the second driving rail. Each first actuator and the corresponding second actuator are electrically connected with the corresponding controller.

According to the slitter of the present disclosure, each first actuator includes a first power output unit. Each second actuator includes a second power output unit. The respective round knife modules are contacted with the corresponding bottom cutter modules.

According to the slitter of the present disclosure, each first actuator includes a first transmission member driven by the first power output unit and geared with the first driving rail. The first driving rail could be a screw rod, and the first transmission member could be a nut geared with the corresponding screw rod. The first driving rail could be a rack, and the first transmission member could be a gear geared with the corresponding rack.

According to the slitter of the present disclosure, each second actuator includes a second transmission member driven by the second power output unit and geared with the second driving rail. The second driving rail could be a screw rod, and the second transmission member could be a nut the geared with the corresponding screw rod. The second driving rail could be a rack, and the second transmission member could be a gear geared with the corresponding rack.

According to the slitter of the present disclosure, the round knife module and the bottom cutter module are respectively moved by the first actuator and the second actuator. A material is allowed to pass between the round knife module and the bottom cutter module while the round knife module and the bottom cutter module are moving. Moreover, the first actuator and the second actuator are connected to the same controller, motion deviations are thereby avoided, and a calibration process is therefore not required. Accordingly, the slitter of the present disclosure is able to rapidly adjust widths of the strips, and abandoned materials during the adjustment process are much less than a conventional slitter.

### BRIEF DESCRIPTION OF DRAWING

The present disclosure can be more fully understood by reading the following detailed description of the embodiment, with reference made to the accompanying drawings as follows:

FIGS. 1 and 2 are perspective views showing the slitter of the present disclosure.

FIGS. 3 and 4 are schematic diagrams showing arrangements of the slitter of the present disclosure.

FIGS. 5 and 6 are schematic diagrams showing operation status of the slitter of the present disclosure.

### DETAILED DESCRIPTION

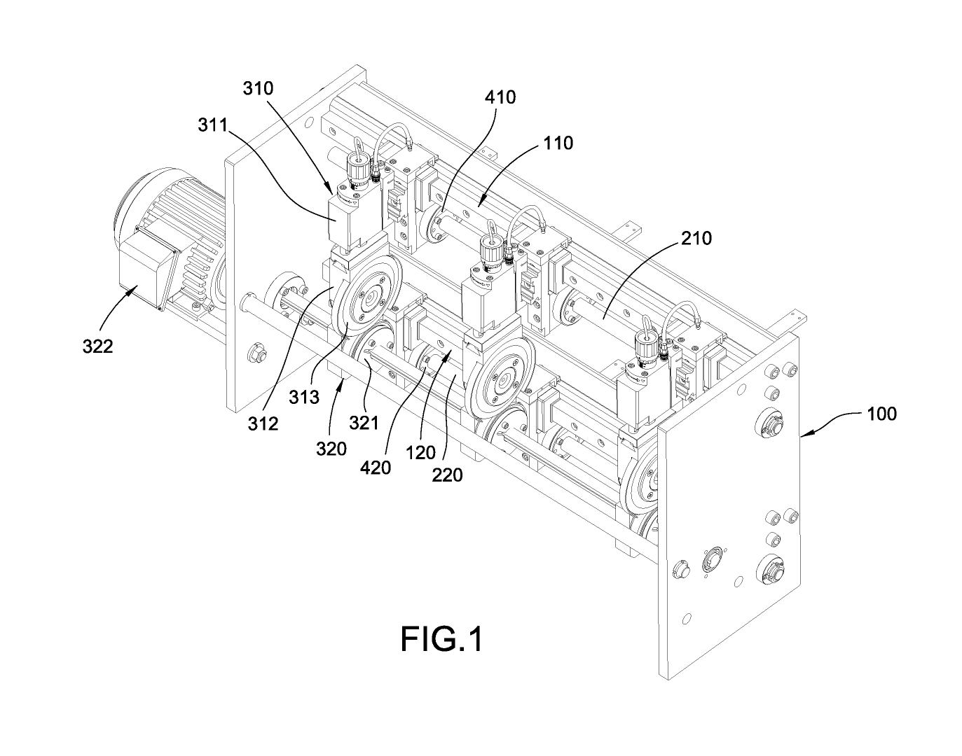

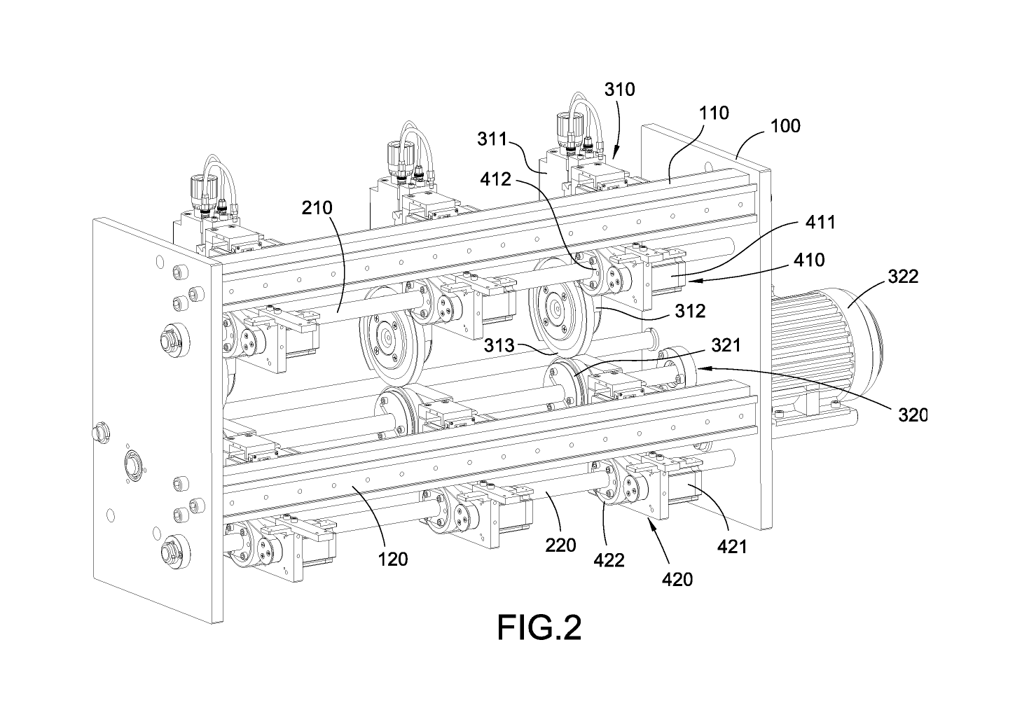

According to FIGS. 1 and 2, a slitter including a base 100, a first slide 110, a second slide 120, a first driving rail 210, a second driving rail 220, multiple round knife modules 310 and multiple bottom cutter modules 320 is provided in an embodiment of the present disclosure.

In the present embodiment, each of the first slide 110 and the second slide 120 is a couple of rods horizontally arranged on the base 100, the first slide 110 and the second slide 120 are arranged at interval and parallel with each other, and the first slide 110 and the second slide 120 are preferably cylinder rods, but scope of the present disclosure should not be limited to the embodiment.

In the present embodiment, the first driving rail 210 and the second driving rail 220 are respectively couples of screw rods horizontally fixed on the base 100 respectively corresponding to the first slide 110 and the second slide 120, and the first driving rail 210 and the second driving rail 220 are respectively arranged parallel with and adjacent to the first slide 110 and second slide 120.

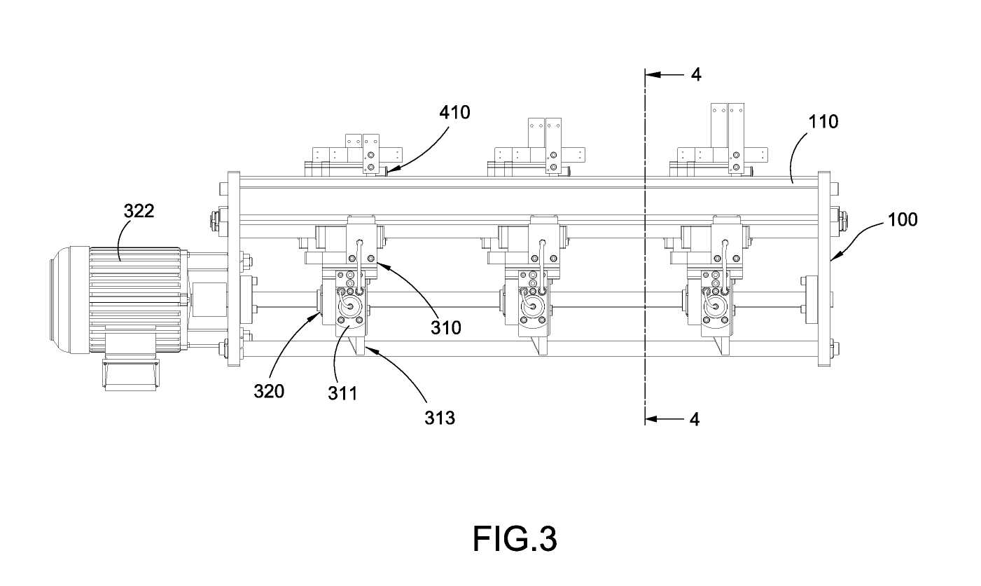

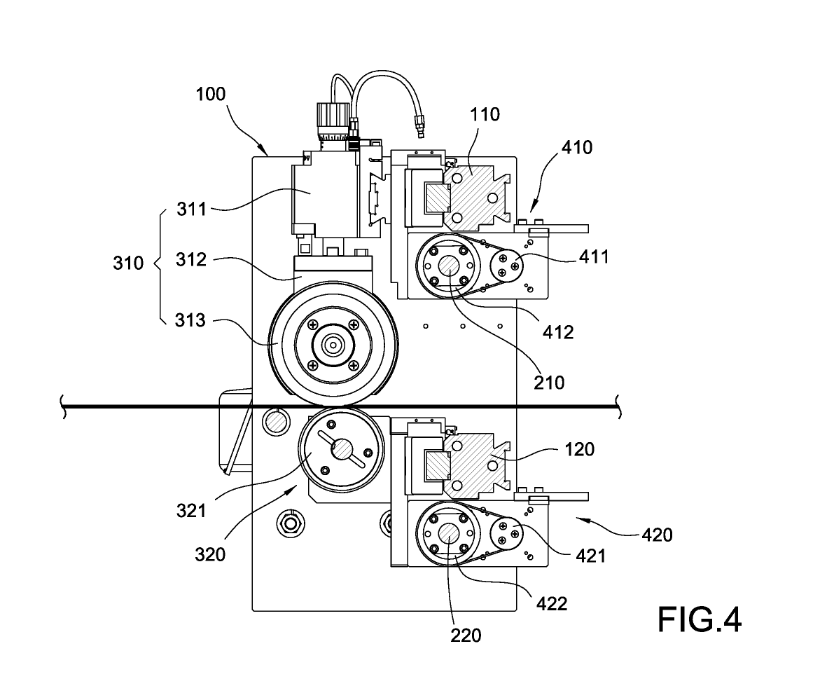

According to FIGS. 3 and 4, the round knife modules 310 are arranged on the first slide 110, each round knife module 310 includes a cutting switch 311, a driver 312, a knife 313 and a first actuator 410, the cutting switch 311 is arranged on the first slide 110 and allowed to horizontally move along the first slide 110, the driver 312 is connected with the cutting switch 311, the knife 313 is of a round shape, the knife 313 is pivotally arranged on the driver 312 and is therefore upright and driven to rotate by the driver 312, the cutting switch 311 is used for moving the knife 313 connected therewith toward or far from the second slide 120. In the present embodiment, the cutting switch 311 and the driver 312 are preferably driven by air pressure, but scope of the present disclosure should not be limited to the embodiment. For example, the driver 312 could be driven by electrical power. The first actuator 410 is connected with the cutting switch 311 and geared with the first driving rail 210. In the present embodiment, each first actuator 410 includes a first power output unit 411 and a first transmission member 412. In the present embodiment, the first power output unit 411 of the first actuator 410 is preferably a motor, but scope of the present disclosure should not be limited thereby, the first transmission member 412 of the first actuator 410 is preferably a nut which is connected with the first power output unit 411 and driven to rotate by the first power output unit 411, the first driving rail 210 is inserted through the first transmission member 412 of the first actuator 410 and the first transmission member 412 of the first actuator 410 is geared with the first driving rail 210. While the first transmission member 412 of the first actuator 410 is driven to rotate by the first power output unit 411, the first transmission member 412 of the first actuator 410 is thereby allowed to horizontally move along the first driving rail 210, and further horizontally move the round knife module 310.

The bottom cutter modules 320 are arranged on the second slide 120 according to positions of the round knife modules 310, each bottom cutter module 320 includes a bottom cutter 321 and a second actuator 420. Each bottom cutter 321 is of a cylinder shape, and the bottom cutters 321 are power transmitted by a driving motor 322, the driving motor 322 is used for driving the respective bottom cutters 321 to rotate. In the present embodiment, the bottom cutters 321 are power transmitted by driving motor 322 about the same shaft and thereby driven to rotate by the driving motor 322, but scope of the present disclosure should not be limited thereby. A position of each bottom cutter module 320 is corresponding to a position of one of the round knife module 310, while the cutting switch 311 of each round knife module 310 moves the knife 313 thereof toward the second slide 120; each knife 313 is contacted with the bottom cutter 321 of the corresponding bottom cutter module 320. The respective of second actuators 420 are geared with the second driving rail 220 by the same means according to aforementioned first actuator 410, each second actuator 420 includes a second power output unit 421 and a second transmission member 422. In the present embodiment, the second power output unit 421 of the second actuator 420 is preferably a motor in various types, the second transmission member 422 of the second actuator 420 is preferably a nut which is power transmitted by the second power output unit 421 and thereby driven to rotate by the second power output unit 421. The second driving rail 220 is inserted through the second transmission member 422 of the second actuator 420 and the second transmission member 422 of the second actuator 420 is geared with the second driving rail 220. While the second transmission member 422 of the second actuator 420 is driven to rotate by the second power output unit 421, the second transmission member 422 of the second actuator 420 is thereby allowed to horizontally move along the second driving rail 220, and further horizontally move the bottom cutter module 320. The material 10 of a strip shape is cut by the knife 313 into multiple strips while continuously transferred pass between the knife 313 and the bottom cutter 321.

In the present embodiment, a controller (not shown in figs.) is arranged corresponding to each couple of round knife module 310 and bottom cutter module 320, each first actuator 410 and the corresponding second actuator 420 are electrically connected with the same corresponding controller. Therefore, each controller is able to drive the round knife module 310 and the bottom cutter module 320 correspondingly connected therewith to move horizontally in the same time.

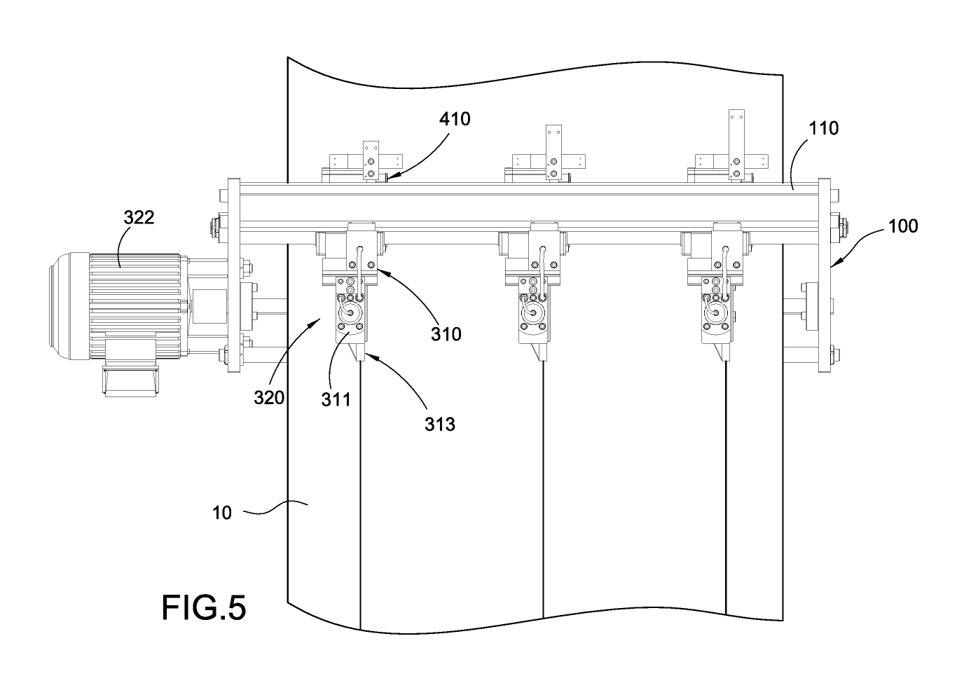

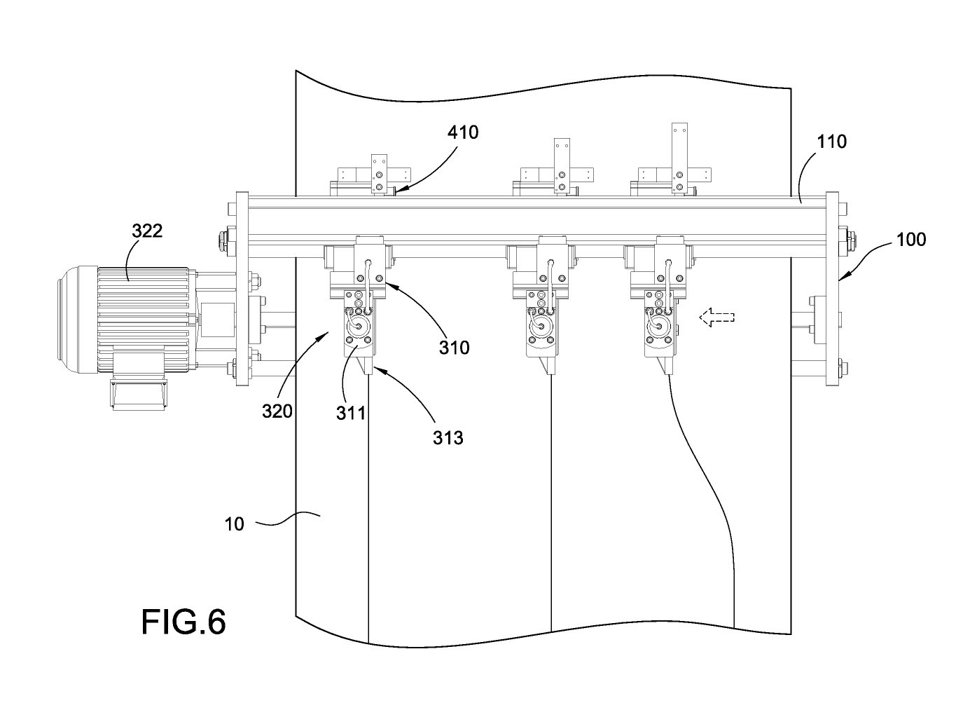

According to the slitter of the present disclosure shown in FIGS. 5 and 6, intervals between the round knife modules 310 and intervals between the bottom cutter modules 320 could be adjusted in the same time by the controllers while feeding material, and widths of the strips are thereby changed. According to the slitter of the present disclosure, each round knife module 310 and the corresponding bottom cutter module 320 are respectively moved by first actuator 410 and second actuator 420. While moving the round knife modules 310 and the bottom cutter modules 320, there is no part between the round knife module 310 and bottom cutter module 320, and the material could be fed in the same time. Moreover, each round knife module 310 and the corresponding bottom cutter module 320 are electrically connected with the same controller, and motion deviations between the round knife module 310 and the bottom cutter module 320 are thereby avoided, an alignment process is not required after adjustment. The abandoned materials generated during the adjustment process will be removed.

The slitter of the present disclosure is able to rapidly change sizes of products, and abandoned materials generated during the adjustment process are much less than a conventional slitter.

The first driving rail 210 and the second driving rail 220 of the present disclosure should not by limited to the embodiment. For example, the first driving rail 210 could be a rack, the first transmission members 412 of the respective first actuators 410 are corresponding gears, the first transmission member 412 is power transmitted by the first power output unit 411 and geared with the first driving rail 210. The second driving rail 220 could be a rack, the second transmission members 422 of the respective second actuators 420 are corresponding gears, the second transmission member 422 is power transmitted by the second power output unit 421 and geared with the second driving rail 220. Furthermore, the first actuator 410 and the first driving rail 210 could be a set of linear motors, the first actuator 410 is a rotor, and the first driving rail 210 is a stator. The second actuator 420 and the second driving rail 220 could be a set of linear motors, the second actuator 420 is a rotor, and the second driving rail 220 is a stator.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the present disclosure as defined in the appended claims.

1. A slitter, comprising:
a first slide;
a first driving rail;
a plurality of round knife modules independent from each other and being arranged on the first slide, a first actuator geared with the first driving rail being arranged on each round knife module;
a second slide;
a second driving rail;
a plurality of bottom cutter modules independent from each other, wherein each bottom cutter module is arranged on the second slide according to positions of one of the round knife module, a second actuator geared with the second driving rail is arranged on each bottom cutter module; and
at least a controller, wherein each first actuator and the corresponding second actuator thereof are electrically connected to the corresponding controller;
wherein each round knife module has a cutting switch and a knife, and the cutting switch moves the knife connected therewith toward or far from the second slide 120; and
wherein each of the round knife modules is moved by the corresponding independent first actuator, and each of the bottom cutter modules is moved by the corresponding independent second actuator.

2. The slitter according to claim 1, wherein each first actuator comprises a first power output unit.

3. The slitter according to claim 1, wherein each second actuator comprises a second power output unit.

4. The slitter according to claim 1, wherein the round knife modules are contacted with corresponding bottom cutter modules.

5. The slitter according to claim 2, wherein each first actuator comprises a first transmission member driven by the first power output unit and geared with the first driving rail.

6. The slitter according to claim 5, wherein the first driving rail is a screw rod, and the first transmission member is a nut geared with the corresponding screw rod.

7. (canceled)

8. The slitter according to claim 3, wherein each second actuator comprises a second transmission member driven by the second power output unit and geared with the second driving rail.

9. The slitter according to claim 8, wherein the second driving rail is a screw rod, and the second transmission member is a nut geared with the corresponding screw rod.

10. (canceled)
